(19) United States
(12) Patent Application Publication
(10) Pub. No.: US 2026/0063569 A1
(43) Pub. Date: Mar. 5, 2026

(54) FUEL CELL CONTAMINATION DETECTION

(71) Applicant: FORD GLOBAL TECHNOLOGIES, LLC, Dearborn, MI (US)

(72) Inventors: Nathan KEMPEMA, Grosse Pointe Farms, MI (US); Daniel WILKOSZ, Saline, MI (US)

(21) Appl. No.: 18/823,391

(22) Filed: Sep. 3, 2024

(51) Int. Cl. G01N 21/94; B60L 58/30; G01N 21/71; G01N 21/85; H01M 8/0444

(52) U.S. Cl. CPC G01N 21/94; B60L 58/30; G01N 21/71; H01M 8/04447; G01N 2021/8578; G01N 2201/0612

(57) ABSTRACT

An automotive fuel cell system with an integrated optical contamination detection mechanism is presented. The automotive fuel cell system includes a fuel cell connected to a hydrogen gas input tube, with an optical coupler. A laser is configured to generate a light beam that is focused by a lens through the optical coupler and into the hydrogen gas input tube. Contaminants flowing through the hydrogen gas input tube emit light back through the optical coupler and lens, enabling the detection and monitoring of these contaminants.

### TECHNICAL FIELD

This disclosure relates to contamination detection in fuel cells.

### BACKGROUND

Proton exchange membrane fuel cell stack unit cells may be vulnerable to degradation when supply fluid streams become contaminated with metal oxide particles, particularly iron or chromium oxide. These contaminants often originate from the corrosion of stainless steel components within the fuel cell system. The introduction of these particles, even at nano-scale sizes, may alter fuel cell performance. Traditional methods for detecting trace particle contamination include filter insertion and system disassembly for sample collection.

### SUMMARY

An automotive fuel cell system includes a fuel cell, a gas input tube, with an optical coupler, in fluid communication with the fuel cell, a laser configured to generate a light beam, and a lens configured to focus the light beam through the optical coupler and into the gas input tube such that contaminants flowing through the gas input tube emit light back through the optical coupler and lens. In some configurations, the automotive fuel cell system includes a spectrometer configured to detect the light back through the optical coupler and the lens. The automotive fuel cell system may also include an optical filter configured to direct the light back through the optical coupler and the lens onto the spectrometer. The spectomermay include a detector such as a photodiode, charge-coupled device, or complementary metal-oxide-semiconductor array. The spectrometer may detect particles in a nano-to micron-scale range. The light beam may heat the contaminants to incandescence. The optical coupler may include a fitting and an optically transparent insert. The optically transparent insert may be sapphire or quartz. The particle contamination sensor may be configured to provide diagnostic information during vehicle operation.

Another automotive fuel cell system includes a fuel cell, a gas input tube in fluid communication with the fuel cell, a laser configured to generate a light beam into the gas input tube, a spectrometer configured to receive emitted light, and an optical coupler configured to direct light emitted, as a result of interaction of the light beam with the contaminants flowing through the gas input tube, to the spectrometer. The automotive fuel cell system may include a lens configured to focus the light beam into the hydrogen gas input tube. In some configurations, the automotive fuel cell system may include an optical filter configured to direct the light beam emitted through the optical coupler and the lens onto the spectrometer. The laser may be a solid-state laser. The light beam may excite the contaminants to emit photons, or the light beam may heat the contaminants to incandescence. The optical coupler may include a fitting with an optically transparent insert. The optically transparent insert may be sapphire or quartz. The fuel cell may allow for real-time monitoring of contaminants in the gas input tube.

Another automotive fuel cell system includes a fuel cell, an interface tube in fluid communication with the fuel cell, a laser configured to generate a light beam, a first optical port coupled to the interface tube and configured to direct the light beam from the laser into the interface tube, a second optical port coupled to the interface tube and positioned non-coaxially with respect to the light beam, and a detector coupled to the second optical port and configured to detect light scattered by contaminants in a gas flowing through the interface tube. The laser may be a solid-state laser.

### BRIEF DESCRIPTION OF THE DRAWINGS

FIG. 1 is a graph of an iron light emission spectrum from a laser-induced breakdown spectroscopy analysis;

FIG. 2 is a graph of a chromium light emission spectrum from a laser-induced breakdown spectroscopy analysis;

FIG. 3 is a schematic diagram of an automotive fuel cell system;

FIG. 4 is a schematic diagram of a single-ended contamination sensing configuration; and

FIG. 5 is a schematic diagram of a dual-ended contamination sensing configuration.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

This disclosure introduces a non-invasive optical sensor designed to detect and analyze contaminant particles in fuel cell gas streams. A sensor may use different light-matter interaction techniques such as elastic light scattering, laser-induced incandescence, or laser-induced breakdown spectroscopy. The presented sensor configuration allows for minor adaptations to accommodate each technique, with a single-ended configuration suitable for both laser-induced incandescence and laser-induced breakdown spectroscopy, while elastic light scattering requires a non-zero arrangement between the light source and detector.

Elastic light scattering refers to the phenomenon where light is scattered by particles or fluctuations in a medium without any change in its wavelength. A solid-state laser may be utilized to achieve elastic light scattering. This process can be explained by different scattering theories depending on the size of the scattering particles relative to the wavelength of the incident light. Rayleigh scattering occurs when the particles are much smaller than the wavelength of light, resulting in a scattered intensity that is inversely proportional to the fourth power of the wavelength. This explains why shorter wavelengths (blue light) are scattered more than longer wavelengths (red light), giving the sky its blue color. When particles are comparable in size to the wavelength of light, Mie scattering becomes significant. This type of scattering is less dependent on wavelength and can explain the white appearance of clouds, which contain water droplets of various sizes.

In laser-induced incandescence, a laser beam heats the particles to incandescence, causing them to emit thermal radiation. The intensity and decay of this radiation are then analyzed, by a spectrometer utilizing thermal emission spectroscopy, to infer particle properties. The process may begin with the laser rapidly heating the particles, typically to temperatures above 4000 K, causing them to emit a broad spectrum of light due to incandescence. As the particles cool down, the emission intensity decreases, and this temporal decay is measured. By analyzing the decay curve, information about the particle size and concentration can be obtained.

The process of laser-induced breakdown spectroscopy typically involves focusing a laser onto the sample, which results in ionization of the material, forming a plasma. The high temperatures in the plasma cause excitation and ionization of the atoms, which then emit light as they return to lower energy states. The resulting emission spectrum contains peaks corresponding to the various elements present in the sample, allowing for qualitative and quantitative analysis by a spectrometer or optical filter utilizing optical emission spectroscopy.

The sensor utilizes a laser diode as its light source, capable of delivering high-power, coherent light in ultraviolet, visible, or near-infrared spectra to the measurement volume. A neodymium-doped yttrium aluminum garnet laser diode may be used as the light source for laser-induced breakdown and laser-induced incandescence. Signal detection may be achieved using a photodiode with an interference filter, to facilitate the capture of light at specific wavelengths. These wavelengths may vary depending on the technique utilized. One configuration may vary wavelengths based on matching the laser diode for elastic light scattering. In another configuration, wavelengths may vary based on two colors red-shifted from the laser in laser-induced incandescence. In still another configuration, wavelengths may vary specific colors associated with particular ion species in laser-induced breakdown spectroscopy.

External hardware provides electrical current for the laser diode and processes the analog signal from the detector. The sensor integrates with the fuel cell system through an optical port configured to withstand high temperatures and pressures. This may be achieved using a stainless-steel fitting, either welded or threaded into the fuel cell system hardware. Optical access is provided by a sapphire or quartz insert, bonded to the metal fitting, or sealed with a gasket or O-ring.

This optical sensing method enables non-invasive detection of nano-or micron-scale particles within the gas stream of a fuel cell system. The sensor's capabilities range from simple qualitative indication of particle presence to more advanced quantitative measurements such as particle diameter or elemental composition, depending on the sensor's complexity. The time resolution of the sensor is sufficient to correlate particle detection with operating conditions, potentially enabling early component degradation detection. Beyond mere detection, the sensor may measure particle presence, atomic composition, and particle size in real time.

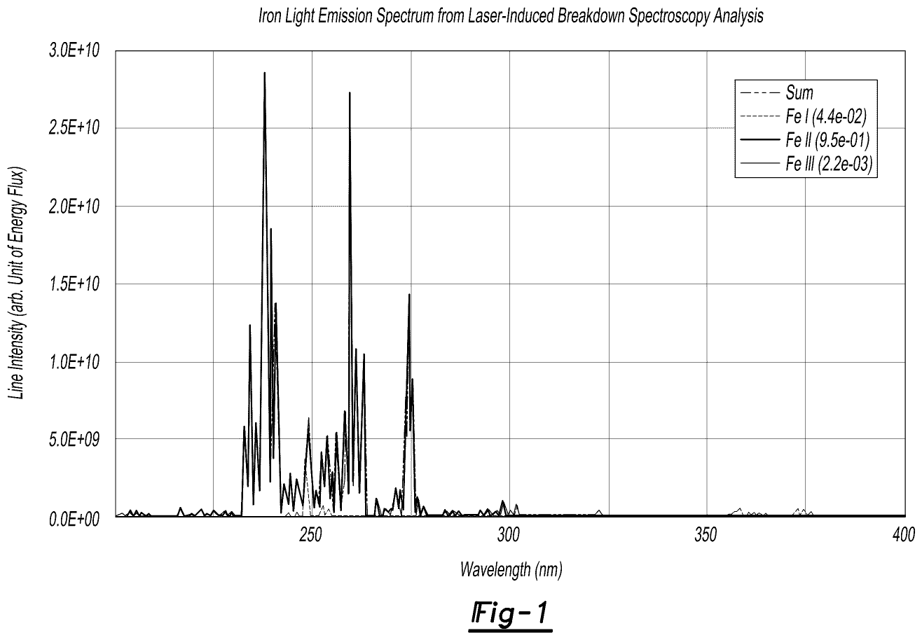

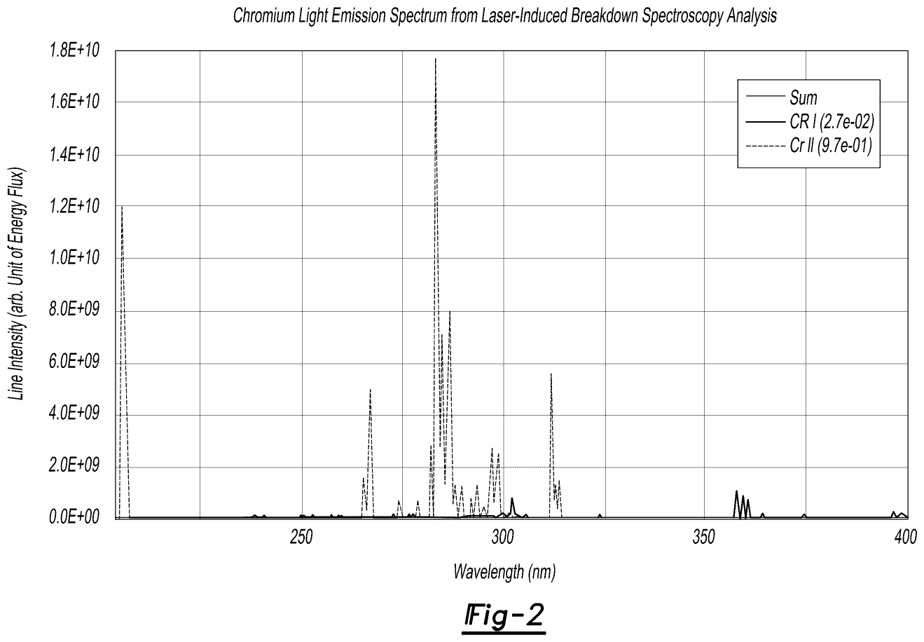

In FIGS. 1 and 2, graphs of light emission spectrums from a laser-induced breakdown spectroscopy analysis are shown. FIG. 1 shows the iron light emission spectrum. The horizontal axis represents the wavelength in nanometers, while the vertical axis shows the line intensity in arbitrary units of energy flux. The graph displays multiple peaks across the spectrum, with the most prominent peaks occurring between 250 nanometers and 300 nanometers. FIG. 2 shows the chromium light emission spectrum where the horizontal axis shows the wavelength in nanometers, while the vertical axis shows the line intensity in arbitrary units of energy flux. The chromium spectrum shows distinct peaks, with the most intense ones appearing around 285 nanometers and 425 nanometers.

The spectra in FIGS. 1 and 2 demonstrate how the different elements, iron and chromium in this example, have unique spectral signatures. This allows a sensor to identify specific contaminants in the fuel cell gas stream. For example, the distinct peaks at 259.9 nanometers and 283.5 nanometers may be used to identify iron and chromium, respectively. The ability to distinguish between different elements and their ionization states allows a sensor to provide information about the composition of contaminant particles. This enables a detection system incorporating a sensor to detect and analyze nano-or micron-scale particles in fuel cell systems, potentially identifying the source of contamination (e.g., component degradation) based on the elemental composition of the detected particles.

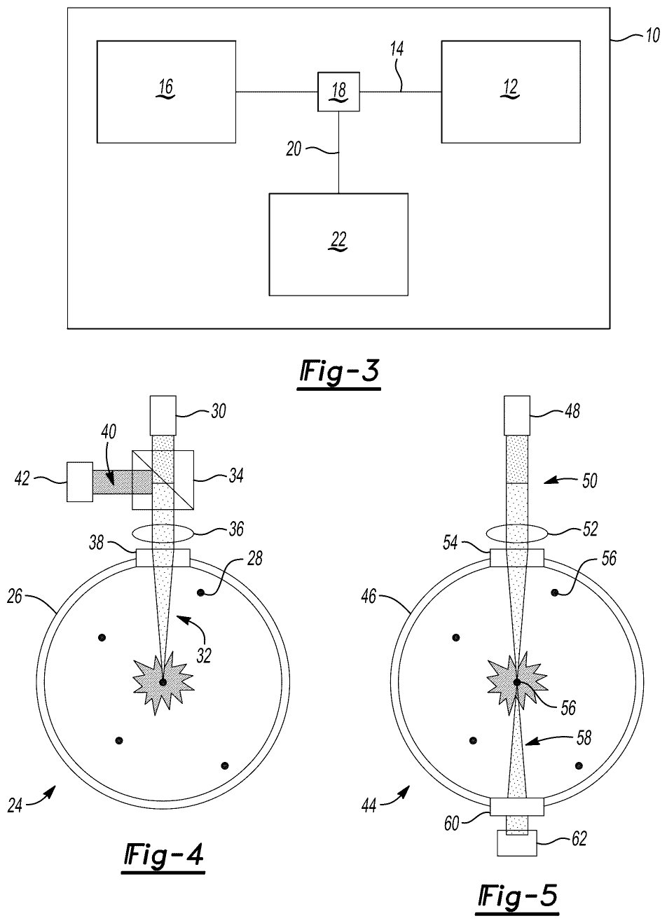

FIG. 3 is a schematic diagram of an automotive fuel cell system 10 with a fuel cell 12. The fuel cell 12 has an interface tube 14 in fluid communication with the fuel cell 12. The interface tube 14 fluidly couples the fuel cell 12 with a fuel cell system component 16. The fuel cell system component 16 may be a fuel tank or an emission outlet depending on the configuration of the automotive fuel cell system 10. Along the interface tube 14 is a detection mechanism 18 configured to detect contaminant flow through the interface tube 14. The detection mechanism 18 may utilize elastic light scattering, laser-induced incandescence, or laser-induced breakdown spectroscopy for contaminant detection. The detection mechanism 18 is coupled via a communication line 20 to a processor 22. This processor 22 is configured to analyze the readout from the detection mechanism 18. The processor 22 may convert the spectral data or light scattering patterns from the detection mechanism 18 into meaningful information about contaminant particle presence, size, or composition. By conducting real-time analysis, the processor 22 may provide timely information about the state of the automotive fuel cell system 10. The processor 22 may also conduct correlation of data from the detection mechanism 18 with operating conditions.

FIGS. 4 and 5 are schematic diagrams of contaminant sensing configurations. In FIG. 4 a single-ended contamination sensing configuration 24 for an automotive fuel cell system is shown. A hydrogen gas input tube 26 is in fluid communication with a fuel cell, where flow and detection of contaminant particles 28 occur. A laser 30 generates a light beam 32, which passes through an optical coating component 34 which may be a beam splitter or dichroic mirror. The optical coating component 34 allows the light beam 32 to pass through while redirecting any reflected light. A lens 36 focuses the light beam 32, which then passes through an optical adapter 38 acting as an optical coupler. The optical adapter 38 interfaces with the hydrogen gas input tube 26, focusing the light beam 32 into the hydrogen gas input tube 26. The light beam is 32 focused to a probe volume with a diameter of approximately 10-30 micron. Inside the hydrogen gas input tube 26, the light beam 32 interacts with the contaminant particles 28, creating a light signal 40 indicative of laser-induced breakdown spectroscopy or laser-induced incandescence. The light signal 40 is reflected back through the optical adapter 38 and lens 36. The optical coating component 34 then directs this reflected light towards a detector 42, which may be a spectrometer, for analysis of the contaminant particles 28.

FIG. 5 is a schematic diagram of a dual-ended contamination sensing configuration 44 for an automotive fuel cell system, with an interface tube 46 in fluid communication with a fuel cell. The interface tube 46 may either be an inlet tube for fuel to the fuel cell or an exhaust outlet from the fuel cell. A laser 48 is configured to generate a light beam 50. This light beam 50 passes through a lens 52 configured to focus the light beam 50 through a first optical port 54, which is coupled to the interface tube 46 and directs the light beam 50 into the interface tube 46. Inside the interface tube 46, the light beam 50 interacts with contaminant particles 56, creating an elastic scattering effect producing a scattered light beam 58. The scattering process used may be either Rayleigh or Mie scattering. A second optical port 60 is coupled to the interface tube 46 and positioned at an angle greater than 0 but less than 180 degrees with respect to the light beam 50 from the laser 48. This angular positioning allows for detection of the scattered light beam 58. Connected to the second optical port 60 is a detector 62. The detector 62 is configured to detect the scattered light beam 58 by the contaminant particles 56 in gas flowing through the interface tube 46.

While exemplary embodiments are described above, it is not intended that these embodiments describe all possible forms encompassed by the claims. Moreover, the words used in the specification are words of description rather than limitation, and it is understood that various changes may be made without departing from the spirit and scope of these disclosed materials.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. An automotive fuel cell system comprising:
a fuel cell;
a gas input tube, including an optical coupler, in fluid communication with the fuel cell;
a laser configured to generate a light beam; and
a lens configured to focus the light beam through the optical coupler and into the hydrogen gas input tube such that contaminants flowing through the hydrogen gas input tube emit light back through the optical coupler and lens.

2. The automotive fuel cell system of claim 1, further comprising a spectrometer configured to detect the light back through the optical coupler and the lens.

3. The automotive fuel cell system of claim 2, further comprising an optical filter configured to direct the light back through the optical coupler and the lens onto the spectrometer.

4. The automotive fuel cell system of claim 2 wherein the spectrometer is coupled with a photodiode detector.

5. The automotive fuel cell system of claim 2 wherein the contaminants are in a nano-to micron-scale range.

6. The automotive fuel cell system of claim 1 wherein the laser is further configured to generate the light beam such that the light beam heats the contaminants to incandescence.

7. The automotive fuel cell system of claim 1 wherein the optical coupler includes a fitting and an optically transparent insert.

8. The automotive fuel cell system of claim 7 wherein the optically transparent insert is sapphire or quartz.

9. An automotive fuel cell system comprising:
a fuel cell;
a hydrogen gas input tube in fluid communication with the fuel cell;
a laser configured to generate a light beam;
a spectrometer; and
an optical coupler configured to direct light emitted, as a result of interaction of the light beam with contaminants flowing through the hydrogen gas input tube, to the spectrometer.

10. The automotive fuel cell system of claim 9, further comprising a lens configured to focus the light beam into the hydrogen gas input tube.

11. The automotive fuel cell system of claim 10, further comprising an optical filter configured to direct light emitted through the optical coupler and the lens onto the spectrometer.

12. The automotive fuel cell system of claim 9 wherein the laser is a neodymium-doped yttrium aluminum garnet laser.

13. The automotive fuel cell system of claim 9 wherein the laser is further configured to generate the light beam such that the light beam excites the contaminants to emit photons.

14. The automotive fuel cell system of claim 9 wherein the laser is further configured to generate the light beam such that the light beam heats the contaminants to incandescence.

15. The automotive fuel cell system of claim 9 wherein the optical coupler includes a fitting and an optically transparent insert.

16. The automotive fuel cell system of claim 15 wherein the optically transparent insert is sapphire or quartz.

17. An automotive fuel cell system comprising:
a fuel cell;
an interface tube in fluid communication with the fuel cell;
a laser configured to generate a light beam;
a first optical port coupled to the interface tube and configured to direct the light beam into the interface tube;
a second optical port coupled to the interface tube and positioned non-coaxially with respect to the light beam; and
a detector coupled to the second optical port and configured to detect light scattered by contaminants in a gas flowing through the interface tube.

18. The automotive fuel cell system of claim 17 wherein the laser is a free-electron laser.
